(19) United States
(12) Patent Application Publication
(10) Pub. No.: US 2006/0033676 A1
(43) Pub. Date: Feb. 16, 2006

(54) Display device

(76) Inventors: Kenneth Faase, Corvalis, OR (US); Timothy L. Weber, Corvalis, OR (US); John Liebeskind, Corvalis, OR (US); Charles C. Morehouse, Cupertino, CA (US); James McKinnell, Salem, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/915,753

(22) Filed: Aug. 10, 2004

(51) Int. Cl. G09G 3/00

(52) U.S. Cl. 345/30

(57) ABSTRACT

A display device includes a base and light valve components formed over the base. The base includes electrical circuitry. Each of the light valve components includes a chamber that defines an optical path, particles within the chamber, and a mechanism for transversely repositioning the particles in relation to the optical path in response to voltages provided by the electrical circuitry.

### BACKGROUND OF THE INVENTION

There is a significant demand for consumer electronics and apparatuses in general that include digital display devices. Such displays employ various arrangements of light valves or optical engines. Unfortunately, complex and/or expensive fabrication processes are often required to make optical engines that are suitable for modern digital display devices.

Some light valve technologies use electrostatics to mechanically actuate moving mirror structures, an approach that historically has involved complex fabrication processes. Moreover, light valves that include moving mirror structures are typically subject to reliability problems such as hinge fatigue and particle contamination blocking rotational paths of the mirrors. Additionally, light valves that include moving mirror structures are typically subject to tolerance stack restrictions which lead to low yield/high die costs and a relatively prohibitive cost for the digital display device.

Thus, it would be useful to be able to provide light valves and digital display devices that do not include moving mirror structures. It would also be useful to be able to manufacture light valves and digital display devices while lessening the typical complexity and cost of prior approaches.

### BRIEF DESCRIPTION OF THE DRAWINGS

Detailed description of embodiments of the invention will be made with reference to the accompanying drawings:

FIG. 1 is a perspective view of a projection display device according to an example embodiment;

FIG. 2 shows electronic paper based on a tri-color system according to an example embodiment;

FIG. 3 is a plot of example terminal velocity calculations as a function of particle size and solvent;

FIGS. 4A and 4B are cross-sectional views of an example embodiment of a reflective optical engine, including an outer ring electrode, in closed and open positions, respectively;

FIGS. 5A and 5B are cross-sectional views of an example embodiment of a reflective optical engine, including an outer wall electrode, in closed and open positions, respectively;

FIGS. 6A and 6B are cross-sectional views of an example embodiment of a transmissive optical engine, including an outer ring electrode, in closed and open positions, respectively;

FIGS. 7A and 7B are cross-sectional views of an example embodiment of a transmissive optical engine, including an outer wall electrode, in closed and open positions, respectively;

FIG. 8 is a perspective view of a spatial light modulator according to an example embodiment;

FIG. 9 is a cross-sectional view of an example optical engine during fabrication;

FIG. 10 is an example process flow for fabricating the optical engine of FIG. 9; and

FIG. 11 is a process flow for a Micro-Electro-Mechanical Systems (MEMS) portion of an optical engine fabrication process according to an example embodiment.

### DETAILED DESCRIPTION

The following is a detailed description for carrying out embodiments of the invention. This description is not to be taken in a limiting sense, but is made merely for the purpose of illustrating the general principles of the invention.

Embodments of the present invention generally involves providing display devices with actuated particle optical engines. By way of example, the particles are charged, substantially opaque, and have micron-scale, sub-micron scale, nanometer scale or other scale dimensions. Micron-scale dimensions refers to dimensions that range from 1 micrometer to a few micrometers in size. Sub-micron scale dimensions refers to dimensions that range from 1 micrometer down to 0.05 micrometers. Nanometer scale dimensions refers to dimensions that range from 0.1 nanometers to 50 nanometers (0.05 micrometers). The optical engines described herein can be used as light valves components in applications including (but not limited to): digital projectors, electronic displays, electronic paper products, PDA displays, transmitted light projectors, transparent displays, flat panel displays, window size transparent displays, billboards, and windows that have electronically controlled transparency.

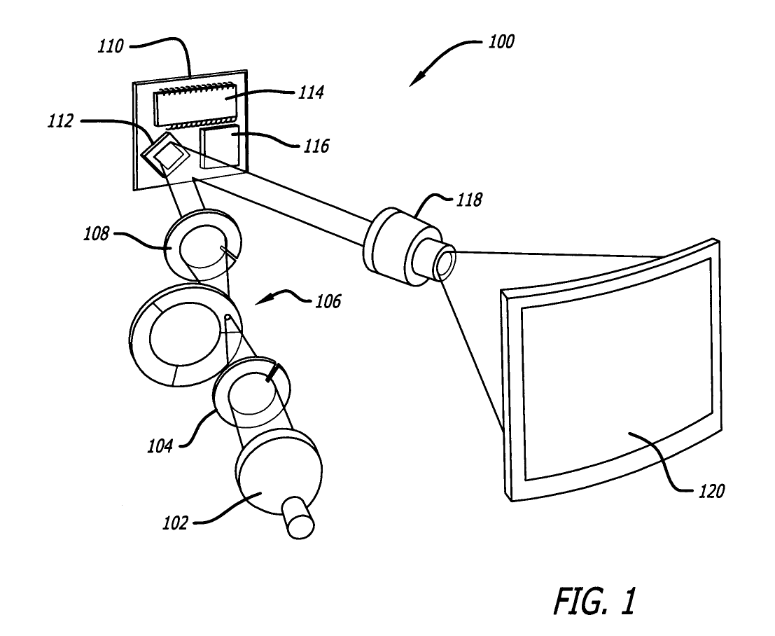

Referring to FIG. 1, a projection display device 100 according to an example embodiment includes a light source 102, a condensing lens 104, a color wheel 106, a shaping lens 108, a circuit board 110 (including a spatial light modulator (SLM) chip 112, a controller/video processor 114, and a memory device 116), a projection lens 118 and a screen 120, configured as shown. The SLM chip 112 includes an array of light valve components, such as the optical engine embodiments described below, which are individually controlled by the controller/video processor 114 to reflect light incident upon certain light valve components toward the projection lens 118. In this example, the color wheel 106 filters light from the condensing lens 104 into red, green, and blue (R, G and B), for example. The “on” and “off” states of the individual light valve components are coordinated with control of the color wheel 106 to generate colors as desired. As an alternative to employing a color wheel, a light dividing mechanism (e.g., a prism) can be used to divide light into multiple components (e.g., R, G, and B), and multiple SLM chips, each dedicated to one of the light components, can be configured to direct their respective reflected light outputs to the projection lens where the colors are combined for projection.

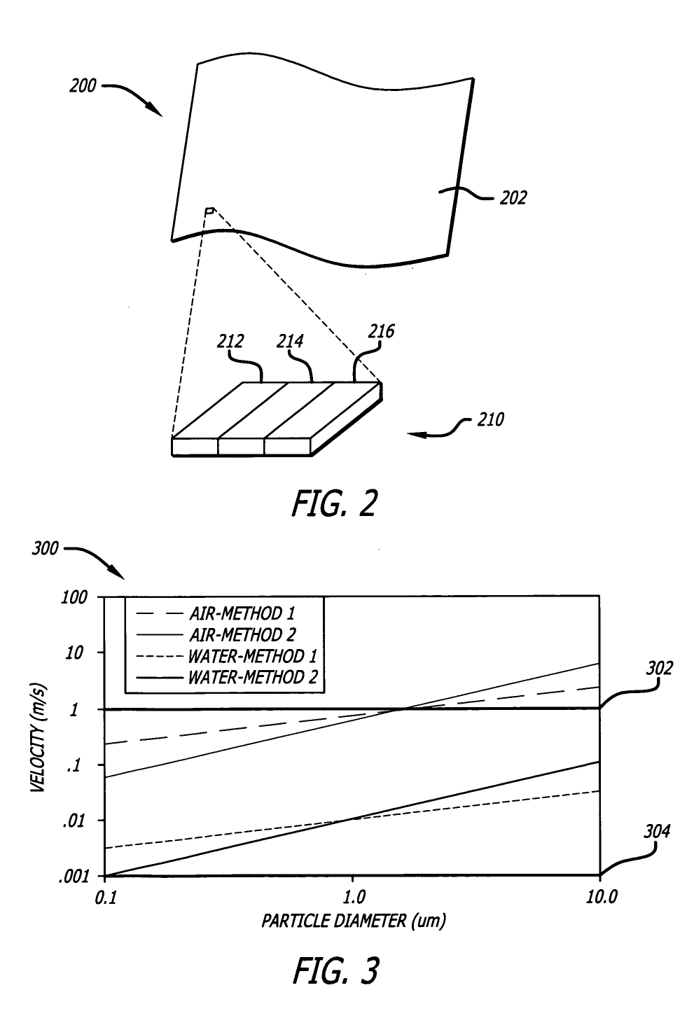

The optical engines described herein can be used to provide other types of tri-color systems. By way of example, and referring to FIG. 2, electronic paper 200 includes an array of light valve components, such as the optical engine embodiments described below, which are individually controlled to reflect light incident upon certain light valve components. In this example, the light valve components are supported in a flexible substrate 202, and each pixel 210 includes subpixels 212, 214 and 216 (e.g., R, G, and B, respectively).

Thus, in various embodiments, a method of using a display device includes providing a display device with actuated particle engines, and using the actuated particle engines to generate pixels for an image to be displayed by the display device.

Apart from the charged particles, the optical engines described herein require no solid moving parts and, therefore, are not subject to hinge fatique, MEMS stiction concerns or severe process control restraints. Also, in various embodiments, the optical engines described herein provide unit-cells that are simpler to manufacture and smaller in size than, for example, moving mirror SLM pixels, thus potentially resulting in lower costs and/or increased resolution.

In an example embodiment, a display device includes a base and light valve components formed over the base. The base includes electrical circuitry. Each of the light valve components includes a chamber that defines an optical path, particles within the chamber, and a mechanism for transversely repositioning the particles in relation to the optical path in response to voltages provided by the electrical circuitry.

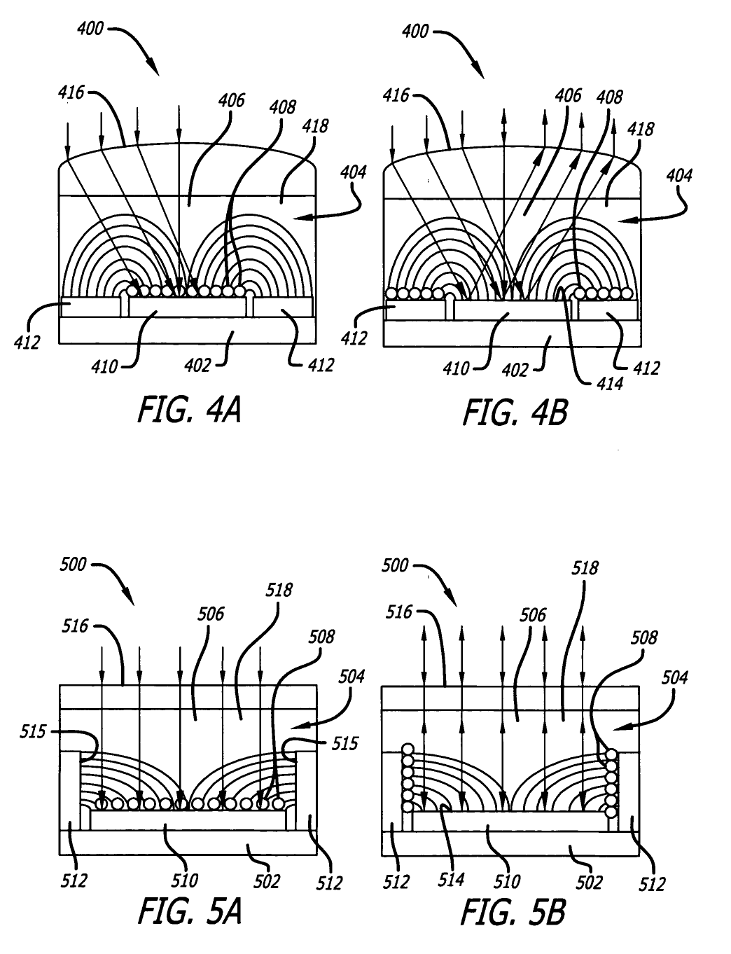

Referring to FIGS. 4A and 4B, in an example embodiment, a reflective optical engine 400 includes a substrate 402 and light valves 404 formed over the substrate 402. (For clarity, a single light valve 404 is shown in these figures.) The substrate (e.g., silicon) includes electrical circuitry, and each of the light valves 404 includes a chamber 406 that defines an optical path, charged particles 408 within the chamber 406, a center electrode 410 positioned within the optical path, and an outer electrode 412 positioned around the center electrode 410. In this example, the center electrode 410 includes a reflective surface 414 (e.g., polished aluminum) facing away from the substrate 402, and the center electrode 410 and the outer electrode 412 are formed over the substrate 402 and are substantially planar. In this example embodiment, the reflective optical engine 400 includes a microlens 416 (e.g., from an array of microlenses positioned adjacent to the light valves such that, for each of the light valves, one of the microlenses directs light along the optical path and incident upon the center electrode). By way of example, the microlens array includes an arrangement of UV cured, optical epoxy microlenses on glass, quartz or some other substrate. The reflective optical engine 400 can also include a solvent material 418 (liquid or gas) within the chamber 406.

In this example, the electrical circuitry is configured to apply electrical potentials to one or more of the center and outer electrodes 410, 412 of each of the light valves 404 such that the charged particles 408 in each of the light valves 404 will be selectively drawn to the center electrode 410 or to the outer electrode 412. The reflective optical engine 400 has two electrically activated states, “on” and “off”. In this example, in the mirror “on” state (FIG. 4B), negatively charged particles 408 (e.g., toner particles) are repulsed from the center electrode 410 (e.g., the inner square portion of a mirror cell), which has a −5V potential applied to it, and the particles 408 are attracted to the outer electrode 412 (e.g., the outer ring of a mirror cell) at ground potential. In this state, light reflects off the particle-free reflective surface 414 of the center electrode 410. This mirror “on” surface is fixed in position and established by a fabrication process as discussed below. In this example, in the mirror “off” state (FIG. 4A), the particles 408 are attracted to the center electrode 410, which has a +5V potential applied to it, and pulled from the outer electrode 412. In this state, the particles 408 coat the reflective surface 414 of the center electrode 410 and absorb the incident light. The microlens array 416 focuses the incident and reflected light onto the reflective surface 414 of the center electrode 410, and away from (within) the outer electrode 412. The focused light increases the mirror array fill factor and subsequent contrast ratio.

Referring to FIGS. 5A and 5B, in an example embodiment, a reflective optical engine 500 includes a substrate 502 and light valves 504 formed over the substrate 502. (For clarity, a single light valve 504 is shown in these figures.) The substrate (e.g., silicon) includes electrical circuitry, and each of the light valves 504 includes a chamber 506 that defines an optical path, charged particles 508 within the chamber 506, a center electrode 510 positioned within the optical path, and an outer electrode 512 positioned around the center electrode 510. In this example, the center electrode 510 includes a reflective surface 514 (e.g., polished aluminum) facing away from the substrate 502. In this example, for each of the light valves, the center electrode 510 and the outer electrode 512 are formed over the substrate 502, and the outer electrode 512 includes an inner wall 515 that is substantially perpendicular to the reflective surface 514. In this example embodiment, the reflective optical engine 500 includes a cover 516 (e.g., glass) that is substantially transparent. The reflective optical engine 500 can also include a solvent material 518 (liquid or gas) within the chamber 506.

In this example, the electrical circuitry is configured to apply electrical potentials to one or more of the center and outer electrodes 510, 512 of each of the light valves 504 such that the charged particles 508 in each of the light valves 504 will be selectively drawn to the center electrode 510 or to the outer electrode 512. The reflective optical engine 500 has two electrically activated states, “on” and “off”. In this example, in the mirror “on” state (FIG. 5B), negatively charged particles 508 (e.g., toner particles) are repulsed from the center electrode 510 (e.g., the inner square portion of a mirror cell), which has a −5V potential applied to it, and the particles 508 are attracted to the outer electrode 512 (e.g., the outer wall of a mirror cell) at ground potential. In this state, light reflects off the particle-free reflective surface 514 of the center electrode 510. This mirror “on” surface is fixed in position and established by a fabrication process as discussed below. In this example, in the mirror “off” state (FIG. 5A), the particles 508 are attracted to the center electrode 510, which has a +5V potential applied to it, and pulled from the outer electrode 512. In this state, the particles 508 coat the reflective surface 514 of the center electrode 510 and absorb the incident light.

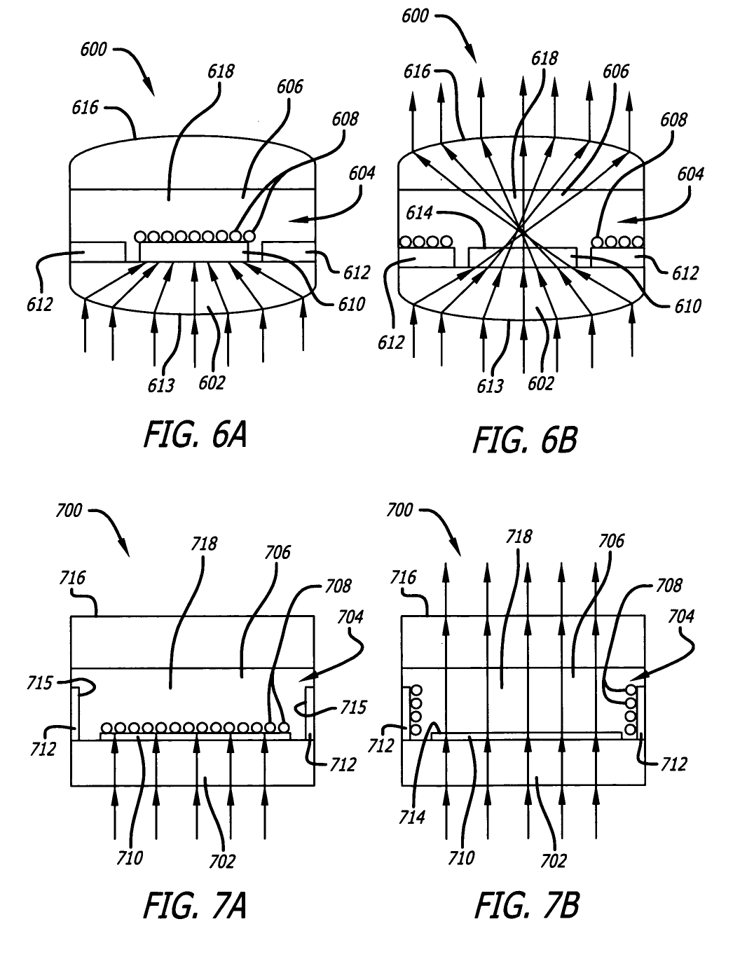

Referring to FIGS. 6A and 6B, in an example embodiment, a transmissive optical engine 600 includes a base 602 and light valves 604 formed over the base 602. (For clarity, a single light valve 604 is shown in these figures.) The base 602 (e.g., a microlens array including transparent traces and/or transparent transistor logic) is substantially transparent. Each of the light valves 604 includes a chamber 606 that defines an optical path, charged particles 608 within the chamber 606, a center electrode 610 positioned within the optical path, and an outer electrode 612 positioned around the center electrode 610. In this example, the center electrode 610 (e.g., Indium Tin Oxide (ITO)) is substantially transparent, and the center electrode 610 and the outer electrode 612 are formed over the base 602 and are substantially planar. In this example, for each of the light valves, the base 602 includes a microlens surface 613 which directs light along the optical path and incident upon the center electrode 610. In this example embodiment, the transmissive optical engine 600 includes another microlens 616 (e.g., from an array of microlenses positioned adjacent to the light valves such that, for each of the light valves, one of the microlenses directs light passing through the center electrode). By way of example, the second microlens array includes an arrangement of UV cured, optical epoxy microlenses on glass, quartz or some other substrate. The transmissive optical engine 600 can also include a solvent material 618 (liquid or gas) within the chamber 606.

In this example, the electrical circuitry is configured to apply electrical potentials to one or more of the center and outer electrodes 610, 612 of each of the light valves 604 such that the charged particles 608 in each of the light valves 604 will be selectively drawn to the center electrode 610 or to the outer electrode 612. The transmissive optical engine 600 has two electrically activated states, “on” and “off”. In this example, in the mirror “on” state (FIG. 6B), negatively charged particles 608 (e.g., toner particles) are repulsed from the center electrode 610 (e.g., the inner square portion of a cell), which has a −5V potential applied to it, and the particles 608 are attracted to the outer electrode 612 (e.g., the outer ring of a cell) at ground potential. In this state, light passes through the center electrode 610 and exits through the microlens 616. The center electrode 610, the mirror “on” transmissive element, is fixed in position and established by a fabrication process as discussed below. In this example, in the mirror “off” state (FIG. 6A), the particles 608 are attracted to the center electrode 610, which has a +5V potential applied to it, and pulled from the outer electrode 612. In this state, the particles 608 coat a surface 614 of the center electrode 610 and absorb the incident light.

Referring to FIGS. 7A and 7B, in an example embodiment, a transmissive optical engine 700 includes a base 702 and light valves 704 formed over the base 702. (For clarity, a single light valve 704 is shown in these figures.) The base 702 (e.g., a substrate including transparent traces and/or transparent transistor logic) is substantially transparent. Each of the light valves 704 includes a chamber 706 that defines an optical path, charged particles 708 within the chamber 706, a center electrode 710 positioned within the optical path, and an outer electrode 712 positioned around the center electrode 710. In this example, the center electrode 710 (e.g., ITO) is substantially transparent. In this example, for each of the light valves, the center electrode 710 and the outer electrode 712 are formed over the base 702, and the outer electrode 712 includes an inner wall 715 that is substantially perpendicular to a surface 714 of the center electrode 710 that faces away from the base 702. In this example embodiment, the transmissive optical engine 700 includes a cover 716 (e.g., glass, or a polymer) that is substantially transparent. The transmissive optical engine 700 can also include a solvent material 718 (liquid or gas) within the chamber 706.

In this example, the electrical circuitry is configured to apply electrical potentials to one or more of the center and outer electrodes 710, 712 of each of the light valves 704 such that the charged particles 708 in each of the light valves 704 will be selectively drawn to the center electrode 710 or to the outer electrode 712. The transmissive optical engine 700 has two electrically activated states, “on” and “off”. In this example, in the mirror “on” state (FIG. 7B), negatively charged particles 708 (e.g., toner particles) are repulsed from the center electrode 710 (e.g., the inner square portion of a cell), which has a −5V potential applied to it, and the particles 708 are attracted to the outer electrode 712 (e.g., the outer wall of a cell) at ground potential. In this state, light passes through the center electrode 710 and exits through the cover 716. The center electrode 710, the mirror “on” transmissive element, is fixed in position and established by a fabrication process as discussed below. In this example, in the mirror “off” state (FIG. 7A), the particles 708 are attracted to the center electrode 710, which has a +5V potential applied to it, and pulled from the outer electrode 712. In this state, the particles 708 coat the surface 714 of the center electrode 710 and absorb the incident light. It should be noted for the various embodiments described herein that an acceptable range of voltages for the electrodes is −50V to +50V depending upon the dielectric strength of the solvents and/or the particles.

In an example embodiment, a display device includes a substrate that is substantially transparent and flexible, and light valve components formed over the substrate. The substrate includes electrical circuitry. Each of the light valve components includes a chamber that defines an optical path, particles within the chamber, and a mechanism for transversely repositioning the particles in relation to the optical path in response to voltages provided by the electrical circuitry.

The “transmitted light” mode engines can be fabricated and/or laminated on glass (or other substrates) to create transparent or substantially transparent displays. Thus, it is envisioned that the principles disclosed herein can be used to provide electronic displays anywhere where glass or other transparent or substantially transparent surfaces are illuminated by natural light or other light sources.

In various embodiments, the particles are selected depending upon a terminal velocity of the particles in the solvent (liquid or gas) as a function of particle size and solvent. By way of example, and referring to FIG. 3, the terminal velocity of spherical toner particles as a function of toner size and solvent can be calculated using two fluidic drag approaches. In this example calculation, velocities were calculated across 0.1-10 μm diameter ranges in both air and water in an electric field of 1e5 V/m (10V across 10 μm). The calculation provides an estimate of the capabilities of a micro-optical switch that spatially transfers toner on and off a mirror to modulate regions of high and low reflectivity. In FIG. 3, a terminal velocity calculations plot 300 includes example particle velocity thresholds 302 and 304 for SLMs and electronic paper displays, respectively. With respect to the particle velocity threshold 302, a “high speed” optical switch requires a terminal velocity of 1 m/s (20 μm travel at a frequency of 50 kHz). By way of example, this high switching speed would be desirable for a SLM in a digital projector and potentially an optical communications switch. With respect to the particle velocity threshold 302, electronic paper-like displays require a much lower terminal velocity 0.001 m/s (20 μm travel at a frequency of 50 Hz). In both calculation methods (denoted “Method 1” and “Method 2” in FIG. 3), particle charge, qₜ, was calculated using a constant surface charge per area of 3.18×10⁻⁵ C/M² multiplied by surface area of the particle. The surface charge per area is based on a 10⁻¹⁴C charge on a 10 μm diameter particle cited in Mizes, Beachner and Ramesh, “Optical Measurements of Toner Motion in a Development Nip”, Journal of Imaging Science and Technology, v44, #3, May, June 2000, pg 200-218, incorporated herein by reference.

With respect to Method 1, as provided by R. Shankar Subramanian adaptation to Clift, Grace and Webber, Bubble, Drops and Particles, Academic Press, 1978, incorporated herein by reference, the terminal velocity, V, of the toner particle can be calculated as:

$$\begin{matrix}\begin{matrix}\begin{matrix}\begin{matrix}V = {( \frac{8 {F}_{es}}{π ρ {d}^{2} {C}_{d}} )}^{1 / 2} \\ {F}_{es} = {q}_{t} E\end{matrix} \\ {C}_{d} = \frac{9}{2} + \frac{24}{Re} for Re \leq 0.01\end{matrix} \\ {C}_{d} = \frac{24}{Re} [ 1 + 0.1315 {Re}^{( 0.82 - 0.05 {log}_{10} Re )} ] for 0.01 < Re \leq 20\end{matrix} \\ Re = \frac{dV ρ}{μ}\end{matrix}$$

where Fₑₛ is the electrostatic force of the particle with particle charge, qₜ, in the electric field, E. The drag coefficient, C_{d}, is calculated from the Reynolds number, where, d, is the particle diameter, p, is the particle density and, μ, is the solvent viscosity. An initial estimate of the particle velocity of 0.01 and 1.0 m/s was used to estimate the Reynolds number and the drag coefficient for water and air, respectively.

With respect to Method 1, as provided by Mizes et al. (above) and Schein, Electrophotography and Development Physics, Laplacian Press, 1996, pg 88, incorporated herein by reference, the terminal velocity, V, of the toner particle can be calculated as:

$$V = \frac{{F}_{es}}{3 π μ d}$$

As shown in FIG. 3, for the purposes of this example, both calculation methods were in fair agreement. The graph suggests that a micro-optical switch using toner particles greater than 1.8 μm in air could achieve the 1 m/s terminal velocity necessary for spatial light modulators in digital projectors. Additionally, the calculations suggest that particles actuated in water are approximately two orders of magnitude slower than particles actuated in air. Although particles actuated in water may not meet the 50 kHz threshold needed for a digital projector, they would be suitable for electronic paper displays.

Additionally, in some embodiments, the determination of particle size (e.g., in water) is a function of the voltages levels used with the substrate electronics (e.g., CMOS). In various embodiments, black liquid toner is capable of providing sufficient frequency response. It should be appreciated, however, that various solvents can be used. By way of example, suitable fluids can be made from the following: 1,1,-diphenylethylene, chlorobenzene, aldehydes, carboxylic acids, ketones, and ester.

In some embodiments, particles are approximately 1-10 μm in diameter. Examples of such optical engines and their design parameters are set forth in the following tables:

TABLE 1

| Device Description/ | Example | Example | Example | Example |
|---|---|---|---|---|
| Parameter | #1 | #2 | #3 | #4 |
| Device Type | SLM | SLM | E-paper | E-paper |
| Solvent | Air | Air | Air | Air |
| Particle Size [um] | 1-10 | 1-10 | 1-10 | 1-10 |
| Inner-Outer Potential | 10 | 10 | 10 | 10 |
| Difference [V] | | | | |
| Pixel Size [um] | 20 | 20 | 20 | 20 |
| Device Design | Ring | Wall | Ring | Wall |
| | Design | Design | Design | Design |
| Inner Electrode | 15 | 15 | 15 | 15 |
| Size [um] | | | | |
| Inner-Outer Electrode | 1 | 1 | 1 | 1 |
| Spacing [um] | | | | |
| Outer Electrode | 3 | 3 | 3 | 3 |
| Size [um] | | | | |
| Distance between | 1 | 1 | 1 | 1 |
| Pixels [um] | | | | |
| Pixel and/or Wall | 10 | 10 | 10 | 10 |
| Height [um] | | | | |
| Particle Velocity [m/s] | 1 | 1 | 1 | 1 |

TABLE 2

| Device Description/ | Example | Example | Example | Example |
|---|---|---|---|---|
| Parameter | #5 | #6 | #7 | #8 |
| Device Type | E-paper | E-paper | E-paper | E-paper |
| Solvent | Water | Water | Air | Air |
| Particle Size [um] | 1-10 | 1-10 | 1-10 | 1-10 |
| Inner-Outer Potential | 10 | 10 | 10 | 10 |
| Difference [V] | | | | |
| Pixel Size [um] | 20 | 20 | 200 | 200 |
| Device Design | Ring | Wall | Ring | Wall |
| | Design | Design | Design | Design |
| Inner Electrode | 15 | 15 | 150 | 150 |
| Size [um] | | | | |
| Inner-Outer Electrode | 1 | 1 | 10 | 10 |
| Spacing [um] | | | | |
| Outer Electrode | 3 | 3 | 30 | 30 |
| Size [um] | | | | |
| Distance between | 1 | 1 | 10 | 10 |
| Pixels [um] | | | | |
| Pixel and/or Wall | 10 | 10 | 100 | 100 |
| Height [um] | | | | |
| Particle Velocity [m/s] | 0.01 | 0.01 | 0.1 | 0.1 |

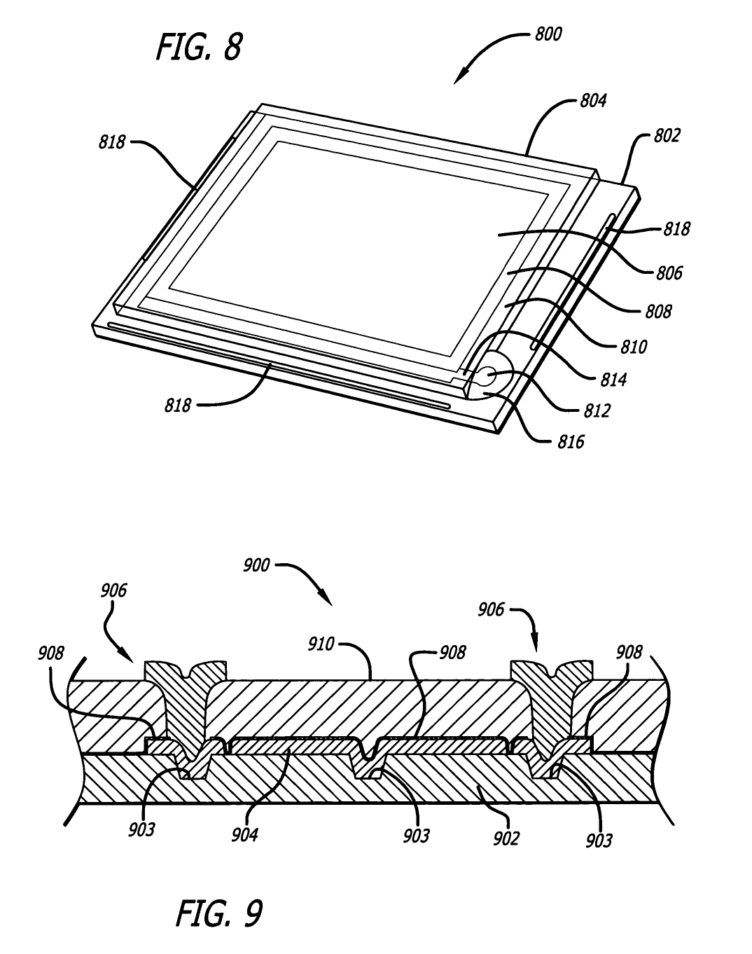

In various example embodiments, a display device such as a spatial light modulator (SLM) includes an array of MEMS-based light valves individually controlled to vary in transmissivity via repositioning of charged particles within the MEMS-based light valves. Referring to FIG. 8, in an example embodiment, a spatial light modulator 800 includes a substrate 802 (e.g., silicon wafer) and a cover layer 804 (e.g., glass). An array of optical engines is formed within a region 806 on the substrate 802. An electrical circuitry routing and alignment tolerance zone 808 separates the optical engines from a seal ring area 810. The optical engines are fluidically connected to a fill port 812 by a trench 814 (e.g., beneath the seal ring). In this example, the fill port 812 has been closed by a fill port sealant 816 (e.g., an adhesive). Bond pad regions 818 facilitate electrical connections to external circuitry.

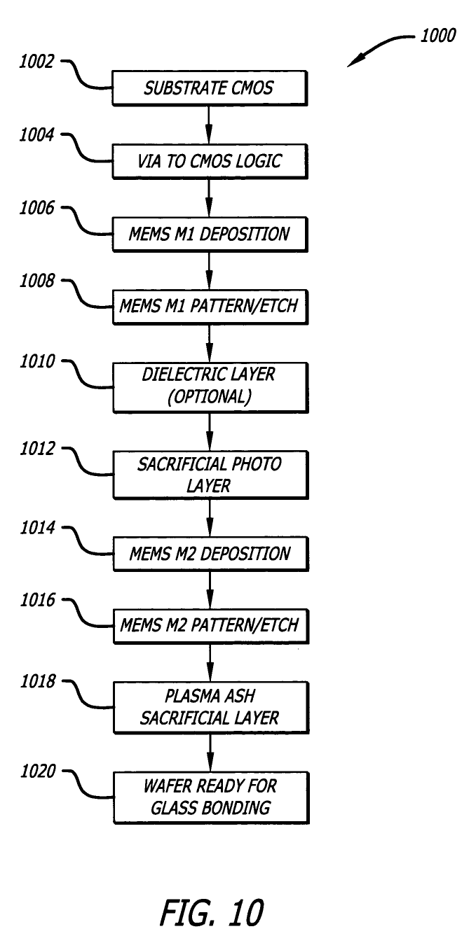

FIG. 9 shows an example optical engine 900 during fabrication, and FIG. 10 shows an example process flow 1000 for fabricating the optical engine 900. Referring to FIG. 9, a substrate 902, vias 903, a first metal layer 904 (M1), a second metal layer 906 (M2), a dielectric layer 908 (optional), and a sacrificial photo layer 910 are shown. Referring to FIG. 10, at step 1002, the substrate 902 (e.g., substrate/CMOS) is provided. For a transmissive engine, as discussed above, a plastic or other substantially transparent substrate with electrical circuitry is provided. At step 1004, vias are formed to the CMOS logic (e.g., with a photo etch process). At step 1006, a MEMS M1 (e.g., AlCu) deposition is performed. For a transmissive engine, as discussed above, a transparent conductive material such as ITO is instead deposited. At step 1008, a MEMS M1 pattern/etch process (e.g., photo etch) is performed to separate the first metal layer 904 into inner and outer electrode portions. At step 1010 (optional), the dielectric layer 908 is formed over the first metal layer 904 to reduce stiction of particles within the optical engine. By way of example, the dielectric layer 908 includes Si₃N₄, SiC or TEOS. For configurations where the outer electrode is a “ring” around the inner electrode and the two electrodes are substantially planar, the following steps are not performed. For configurations where the outer electrode is a “wall” around the inner electrode, the process flow 1000 advances to subsequent steps. At step 1012, vias are formed in the dielectric layer 908, if present, then the sacrificial photo layer 910 is provided as shown. At step 1014, a MEMS M2 (e.g., AlCu) deposition is performed. At step 1016, a MEMS M2 pattern/etch process is performed to form the outer “wall” electrode. At step 1018, the sacrificial photo layer 910 is removed with a plasma ash process, resulting at step 1020 with a wafer that is ready for MEMS (seal ring) as discussed below.

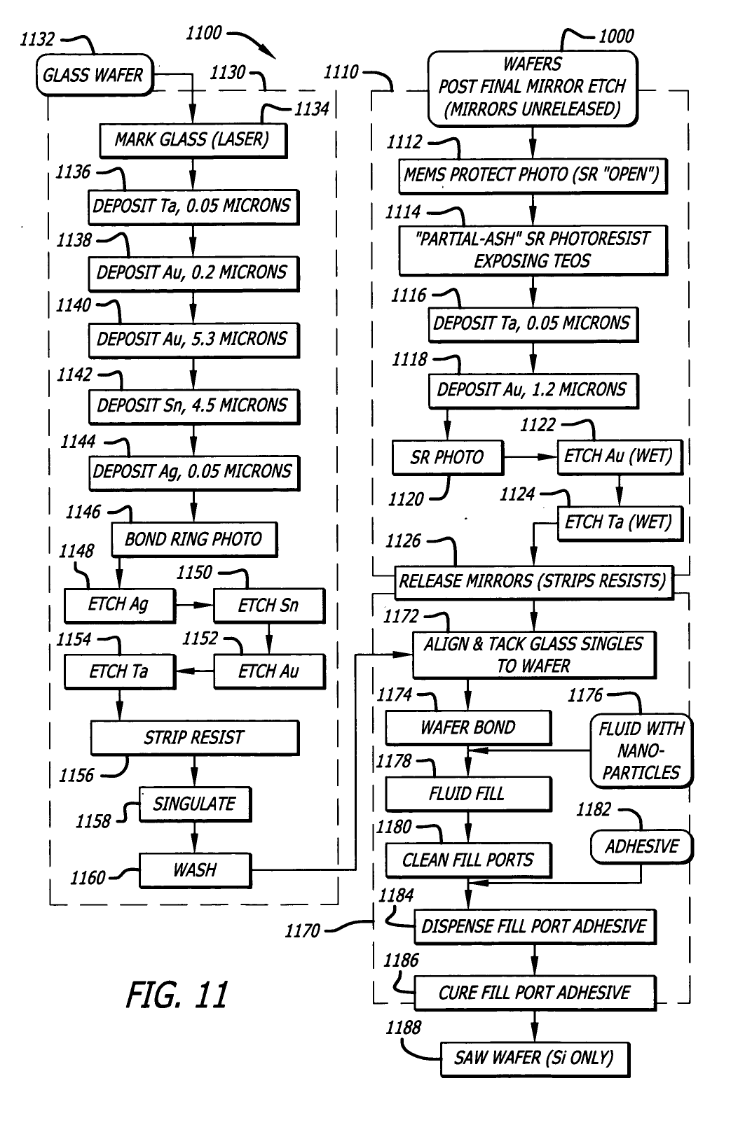

FIG. 11 shows an example process flow 1100 for a MEMS portion of an optical engine fabrication process. In this example, the steps include three groups of processes, namely, Si wafer processes 1110, glass processes 1130 and assembly processes 1170 as shown within dashed lines. With respect to the Si wafer processes 1110, at step 1112, a layer of photoresist is applied for forming the seal ring (SR) which functions to seal the array. At step 1114, a “partial ash” is performed to open the SR area. At steps 1116 and 1118, Ta (e.g., 0.05 microns) and Au (e.g., 1.2 microns) are deposited, respectively. At step 1120, a photostep is employed to form the seal ring. At steps 1122 and 1124, non-photostepped Au and Ta are etched (e.g., wet etched) away. At step 1126, the mirrors are released (e.g., by performing a complete ash). If the sacrificial layer is Si, a plasma etch is performed.

With respect to the glass processes 1130, a glass wafer 1132 is marked at step 1134 (e.g., with a laser) with alignment marks which have mating marks on the Si layer. Next, glass/silicon bonding material is deposited. In this example, there is a ring seal on both the Si and the glass. More specifically, at step 1136, Ta (e.g., 0.05 microns) is deposited. At step 1138, Au (e.g., 0.2 microns) is deposited. At step 1140, Au (e.g., 5.3 microns) is deposited. At step 1142, Sn (e.g., 4.5 microns) is deposited. At step 1144, Ag (e.g., 0.05 microns) is deposited to prevent corrosion/oxidation. At step 1146, ring photo is applied. At steps 1148, 1150, 1152 and 1154, Ag, Sn, Au and Ta are etched, respectively. At step 1156, the resist is stripped (e.g., by performing an ash). At step 1158, glass singles are created (e.g., by sawing or scribing), followed at step 1160 by a wash.

With respect to the assembly processes 1170, at step 1172, the glass singles are aligned and tacked to the Si wafer. At step 1174, the two seal ring portions are bonded together, e.g., with pressure and heat, between the Au of the Si wafer) and the Sn (of the glass). In this example, a fluid 1176 with nanoparticles is injected at step 1178 through the fill port. An adhesive 1182 (e.g., a two-part epoxy) is dispensed at step 1184 into the fill port. At step 1186, the adhesive is cured. At step 1188, the wafer is sawed (for Si only).

As described herein, optical engines can be fabricated with a single MEMS mask layer (with additional layers for logic). Thus, in an example embodiment, a method of making a display device includes providing a substrate, and fabricating on the substrate actuated particle engines, absent driving logic, with a single MEMS mask layer.

In another embodiment, a method of making a display device includes providing a substrate that includes integrated electronics, fabricating light engines on the substrate (each of the light engines including a chamber, which defines an optical path through the light engine, and electrodes that are electrically connected to the integrated electronics), providing transparent covers for the light engines, selecting charged particles that are substantially opaque, and sealing the charged particles within the chambers such that output voltages applied to the electrodes by the integrated electronics cause the charged particles to move transversely across the optical paths. In some embodiments, as described above, the charged particles along with a solvent are sealed within the chambers, and the charged particles are selected depending upon a relationship between a size and a terminal velocity of the particles in the solvent.

Although the present invention has been described in terms of the example embodiments above, numerous modifications and/or additions to the above-described embodiments would be readily apparent to one skilled in the art. It is intended that the scope of the present invention extend to all such modifications and/or additions.

We claim:

1. A display device including:
a base including electrical circuitry; and
light valve components formed over the base, each of the light valve components including a chamber that defines an optical path, particles within the chamber, and means for transversely repositioning the particles in relation to the optical path in response to voltages provided by the electrical circuitry.

2. The display device of claim 1, wherein the base is substantially transparent.

3. The display device of claim 1, wherein the base includes an array of microlenses.

4. The display device of claim 1, wherein the particles are nanoparticles.

5. The display device of claim 1, wherein the particles are approximately 1-10 μm in diameter.

6. The display device of claim 1, wherein the particles are substantially opaque.

7. The display device of claim 1, wherein the particles are toner particles.

8. The display device of claim 1, wherein each of the light valve components further includes a liquid within the chamber.

9. The display device of claim 8, wherein the particles are selected depending upon a terminal velocity of the particles in the liquid as a function of particle size.

10. The display device of claim 1, wherein each of the light valve components further includes a gas within the chamber.

11. The display device of claim 10, wherein the particles are selected depending upon a terminal velocity of the particles in the gas as a function of particle size.

12. The display device of claim 1, wherein the particles are charged, and the means for transversely repositioning includes electrodes.

13. The display device of claim 12, wherein the electrodes are formed over the base.

14. The display device of claim 12, wherein the electrodes include a center electrode positioned within the optical path, the center electrode including a reflective surface facing away from the base, and an outer electrode positioned around the center electrode.

15. The display device of claim 14, wherein the center and outer electrodes are substantially planar.

16. The display device of claim 14, further including:
an array of microlenses positioned adjacent to the light valve components such that, for each of the light valve components, one of the microlenses directs light along the optical path and incident upon the center electrode.

17. The display device of claim 14, wherein, for each of the light valve components, the outer electrode includes an inner wall that extends above and is substantially perpendicular to the reflective surface of the center electrode.

18. The display device of claim 12, wherein the electrodes include a center electrode positioned within the light path, the center electrode being substantially transparent, and an outer electrode positioned around the center electrode.

19. The display device of claim 18, wherein the center electrode and the outer electrode are substantially planar.

20. The display device of claim 18, wherein the center electrode includes a surface facing away from the base, and the outer electrode includes an inner wall that is substantially perpendicular to the surface.

21. A display device including:
a substrate including electrical circuitry; and
light valves formed over the substrate, each of the light valves including
a chamber that defines an optical path,
charged particles within the chamber,
a center electrode positioned within the optical path, the center electrode including a reflective surface facing away from the substrate, and
an outer electrode positioned around the center electrode;
wherein the electrical circuitry is configured to apply electrical potentials to one or more of the center and outer electrodes of each of the light valves such that the charged particles in each of the light valves will be selectively drawn to the center electrode or to the outer electrode.

22. The display device of claim 21, wherein, for each of the light valves, the center electrode and the outer electrode are formed over the substrate and are substantially planar.

23. The display device of claim 22, further including:
an array of microlenses positioned adjacent to the light valves such that, for each of the light valves, one of the microlenses directs light along the optical path and incident upon the center electrode.

24. The display device of claim 21, wherein, for each of the light valves, the center electrode and the outer electrode are formed over the substrate, and the outer electrode includes an inner wall that extends above and is substantially perpendicular to the reflective surface.

25. The display device of claim 21, wherein the particles are nanoparticles.

26. The display device of claim 21, wherein the particles are approximately 1-10 μm in diameter.

27. The display device of claim 21, wherein the particles are substantially opaque.

28. The display device of claim 21, wherein the particles are toner particles.

29. The display device of claim 21, wherein each of the light valves further includes a liquid within the chamber.

30. The display device of claim 29, wherein the particles are selected depending upon a terminal velocity of the particles in the liquid as a function of particle size.

31. The display device of claim 21, wherein each of the light valves further includes a gas within the chamber.

32. The display device of claim 31, wherein the particles are selected depending upon a terminal velocity of the particles in the gas as a function of particle size

33. A display device including:
a base including electrical circuitry, the base being substantially transparent;
a cover that is substantially transparent; and
light valves between the base and the cover, each of the light valves including
a chamber that defines an optical path,
charged particles within the chamber,
a center electrode positioned within the optical path, the center electrode being substantially transparent, and
an outer electrode positioned around the center electrode;
wherein the electrical circuitry is configured to apply electrical potentials to one or more of the center and outer electrodes of each of the light valves such that the charged particles in each of the light valves will be selectively drawn to the center electrode or to the outer electrode.

34. The display device of claim 33, wherein, for each of the light valves, the center electrode and the outer electrode are formed over the base and are substantially planar.

35. The display device of claim 34, wherein the base includes a base array of microlenses positioned adjacent to the light valves such that, for each of the light valves, one of the microlenses redirects light entering the light valve.

36. The display device of claim 34, wherein the cover includes a cover array of microlenses positioned adjacent to the light valves such that, for each of the light valves, one of the microlenses redirects light exiting the light valve.

37. The display device of claim 33, wherein, for each of the light valves, the center electrode and the outer electrode are formed over the base, the center electrode includes a top surface facing the cover, and the outer electrode includes an inner wall that extends above and is substantially perpendicular to the top surface.

38. The display device of claim 33, wherein the particles are nanoparticles.

39. The display device of claim 33, wherein the particles are approximately 1-10 μm in diameter.

40. The display device of claim 33, wherein the particles are substantially opaque.

41. The display device of claim 33, wherein the particles are toner particles.

42. The display device of claim 33, wherein each of the light valves further includes a liquid within the chamber.

43. The display device of claim 42, wherein the particles are selected depending upon a terminal velocity of the particles in the liquid as a function of particle size.

44. The display device of claim 33, wherein each of the light valves further includes a gas within the chamber.

45. The display device of claim 44, wherein the particles are selected depending upon a terminal velocity of the particles in the gas as a function of particle size.

46. A display device including:
a substrate that is substantially transparent and flexible, the substrate including electrical circuitry; and
light valve components formed over the substrate, each of the light valve components including a chamber that defines an optical path, particles within the chamber, and means for transversely repositioning the particles in relation to the optical path in response to voltages provided by the electrical circuitry.

47. The display device of claim 46, wherein the substrate is made of a plastic material.

48. The display device of claim 46, wherein the particles are nanoparticles.

49. The display device of claim 46, wherein the particles are approximately 1-10 μm in diameter.

50. The display device of claim 46, wherein the particles are substantially opaque.

51. The display device of claim 46, wherein the particles are toner particles.

52. The display device of claim 46, wherein each of the light valve components further includes a liquid within the chamber.

53. The display device of claim 52, wherein the particles are selected depending upon a terminal velocity of the particles in the liquid as a function of particle size.

54. The display device of claim 46, wherein each of the light valve components further includes a gas within the chamber.

55. The display device of claim 54, wherein the particles are selected depending upon a terminal velocity of the particles in the gas as a function of particle size.

56. The display device of claim 46, wherein the particles are charged, and the means for transversely repositioning includes electrodes.

57. The display device of claim 56, wherein the electrodes are formed over the substrate.

58. The display device of claim 56, wherein the electrodes include a center electrode positioned within the light path, the center electrode being substantially transparent, and an outer electrode positioned around the center electrode.

59. The display device of claim 58, wherein the center electrode includes a surface facing away from the substrate, and the outer electrode includes an inner wall that extends above and is substantially perpendicular to the surface.

60. The display device of claim 46, wherein the light valve components are configured to provide tri-color pixels.

61. A spatial light modulator (SLM) including:
an array of MEMS-based light valves individually controlled to vary in transmissivity via repositioning of charged particles within the MEMS-based light valves.

62. The spatial light modulator (SLM) of claim 61, wherein each of the light valves defines an optical path and includes a reflective electrode that is fixed in position within the optical path.

63. The spatial light modulator (SLM) of claim 61, wherein each of the light valves defines an optical path and includes a substantially transparent electrode that is fixed in position within the optical path.

64. A method of using a display device including:
providing a display device with actuated particle engines; and
using the actuated particle engines to generate pixels for an image to be displayed by the display device.

65. A method of making a display device including:
providing a substrate; and
fabricating on the substrate actuated particle engines, absent driving logic, with a single MEMS mask layer.

66. A method of making a display device including:
providing a substrate that includes integrated electronics;
fabricating light engines on the substrate, each of the light engines including a chamber, which defines an optical path through the light engine, and electrodes that are electrically connected to the integrated electronics;
providing transparent covers for the light engines;
selecting charged particles that are substantially opaque; and
sealing the charged particles within the chambers such that output voltages applied to the electrodes by the integrated electronics cause the charged particles to move transversely across the optical paths.

67. The method of making a display device of claim 66, wherein the charged particles along with a solvent are sealed within the chambers, and the charged particles are selected depending upon a relationship between a size and a terminal velocity of the particles in the solvent.
